(19) United States
(12) Patent Application Publication
(10) Pub. No.: US 2025/0022199 A1
(43) Pub. Date: Jan. 16, 2025

(54) INFORMATION MANAGEMENT PROGRAM AND INFORMATION MANAGEMENT METHOD

(71) Applicant: Brother Kogyo Kabushiki Kaisha, Nagoya (JP)

(72) Inventors: Raizo Kosaka, Nagoya (JP); Yuma Ueda, Okazaki (JP); Ryo Yasui, Nagoya (JP); Ryo Yamamoto, Edogawa (JP); Hirotaka Sato, Nagoya (JP)

(21) Appl. No.: 18/899,843

(22) Filed: Sep. 27, 2024

Related U.S. Application Data
(63) Continuation of application No. PCT/JP2023/009799, filed on Mar. 14, 2023.

(30) Foreign Application Priority Data
Mar. 28, 2022 (JP) 2022-052169

(51) Int. Cl. G06T 11/60; G06F 3/0484

(52) U.S. Cl. CPC G06T 11/60; G06F 3/0484

(57) ABSTRACT

A non-transitory computer readable storage medium stores an information management program executable by a computer of an information editing system. The information editing system includes a display and an operation unit and being configured to edit an object within an area displayed on the display via the operation unit. The information management program causes the computer to perform operations including: storing a history data record that indicates a history corresponding to an edit operation performed on the object within the area displayed on the display via the operation unit; and changing a change condition for a storage state of the history data record stored in the storing when a condition change operation for changing the change condition is performed via the operation unit.

### REFERENCE TO RELATED APPLICATIONS

This is a continuation application of International Application No. PCT/JP2023/009799 filed on Mar. 14, 2023, which claims priority from Japanese Patent Application No. 2022-052169 filed on Mar. 28, 2022. The entire contents of the aforementioned applications are incorporated herein by reference.

### BACKGROUND ART

A known information management system edits information displayed on a display and stores the edited information. For example, a known document management system edits a document displayed on a display. The document management system sets a retention period for the edited document. When the retention period has elapsed, the document management system deletes the document and its associated file from the storage device, thereby changing the storage state of the document.

### SUMMARY

According to an aspect of the disclosure, a non-transitory computer readable storage medium stores an information management program executable by a computer of an information editing system. The information editing system includes a display and an operation unit and edits an object within an area displayed on the display via the operation unit. The information management program causes the computer to perform operations including: storing a history data record that indicates a history corresponding to an edit operation performed on the object within the area displayed on the display via the operation unit; and changing a change condition for a storage state of the history data record stored in the storing when a condition change operation for changing the change condition is performed via the operation unit.

According to another aspect of the disclosure, an information editing system includes a display and an operation unit and edits an object within an area displayed on the display via the operation unit. A method for managing information in the information editing system includes: storing a history data record that indicates a history corresponding to an edit operation performed on the object within the area displayed on the display via the operation unit; and changing a change condition for a storage state of the history data record stored in the storing when a condition change operation for changing the change condition is performed via the operation unit.

### BRIEF DESCRIPTION OF THE DRAWINGS

FIG. 1 shows an electrical configuration of a notebook editing system.

FIG. 2 is a conceptual diagram of an account storage area.

FIG. 3 is a conceptual diagram of a history storage area.

FIG. 4 is a conceptual diagram of a condition storage area.

FIG. 5 illustrates a notebook selection window.

FIG. 6 illustrates a page editing window.

FIG. 7 is a diagram illustrating a history settings window.

FIG. 8 is a flowchart of a main process.

FIG. 9 is a flowchart of an editing process.

FIG. 10 is a flowchart of a management process.

FIG. 11 is a flowchart of a first state change process.

FIG. 12 is a flowchart of a retention period change process.

FIG. 13 is a flowchart of a retention period change process.

FIG. 14 is a flowchart of a second state change process.

### DESCRIPTION

In the above-described document management system, since the storage state of a document is changed for each file, the storage state of necessary information within the document may be also changed. Alternatively, in the document management system, only certain users may have the right to change the storage state of a document. Due to these reasons, it may be difficult for users to manage the storage state of information in the document management system.

An object of the present disclosure is to provide an information management program and an information management method that allows a user to easily manage the storage state of information.

### Outline of Notebook Editing System 1

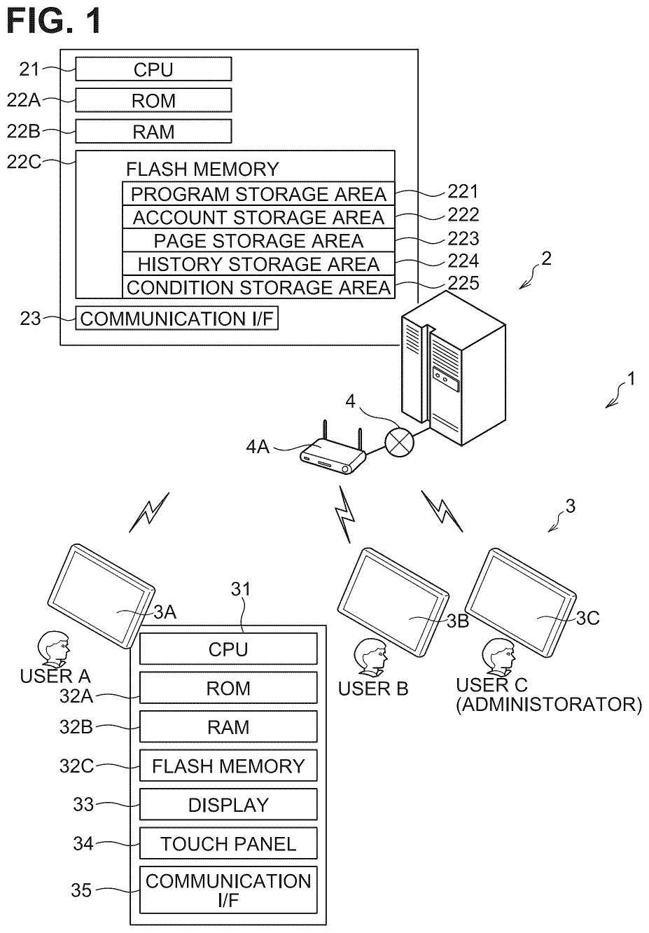

As shown in FIG. 1, a notebook editing system 1 includes a server 2 and user terminals 3A, 3B, and 3C. The server 2 is communicably connected to an access point 4A via a network line 4. The user terminals 3A, 3B, and 3C are connected to the access point 4A by radio so as to be able to communicate with each other. The user terminals 3A to 3C are tablet terminals, and have the same basic configurations. The user terminals 3A to 3C are collectively referred to as “user terminals 3” when any of them is not specified.

In the present embodiment, the user of the user terminal 3A is “user A”. The user of the user terminal 3B is “user B”. The user of the user terminal 3C is “user C”. The user C is an administrator of the notebook editing system 1. The administrator user is called an “administrator user”, and the non-administrator user is called a “standard user”.

### Electrical Configuration of Server 2

As shown in FIG. 1, the server 2 includes a CPU 21, a ROM 22A, a RAM 22B, a flash memory 22C, and a communication I/F 23. The CPU 21 controls the server 2. The ROM 22A stores information required by the CPU 21 during the execution of various programs. The ROM 22A stores, for example, an upper limit of a retention period for each edit attribute. The RAM 22B temporarily stores data during the execution of processes by the CPU 21.

The flash memory 22C is a nonvolatile storage device, and includes a program storage area 221, an account storage area 222, a page storage area 223, a history storage area 224, and a condition storage area 225. The program storage area 221 stores a control program to be executed by the CPU 21. The account storage area 222 stores account information.

The page storage area 223 stores page information. The history storage area 224 stores history data records. The condition storage area 225 stores change conditions. Page information, history data records, and change conditions corresponding to a single notebook is collectively referred to as “notebook information”. The communication I/F 23 is a communication module for the server 2 to communicate with the user terminals 3A to 3C via the network line 4 and the access point 4A.

### Electrical Configuration of User Terminal 3

As shown in FIG. 1, the user terminal 3 includes a CPU 31, a ROM 32A, a RAM 32B, a flash memory 32C, a display 33, a touch panel 34, and a communication interface (I/F) 35. The CPU 31 controls the user terminal 3. The ROM 32A stores information required by the CPU 31 during the execution of various programs. The RAM 32B temporarily stores data during the execution of processes by the CPU 31. The flash memory 32C stores a control program to be executed by the CPU 31.

The display 33 is a liquid crystal display and displays various information under the control of the CPU 31. The touch panel 34 is installed on the surface of the display 33 and detects the contact position of a pen or finger on the display 33. When detecting an operation by the user, the touch panel 34 outputs a signal corresponding to the detected operation to the CPU 31. The communication I/F 35 is a communication module for the user terminal 3 to communicate with the server 2 via the network line 4 and the access point 4A.

### Basic Operation of Notebook Editing System 1

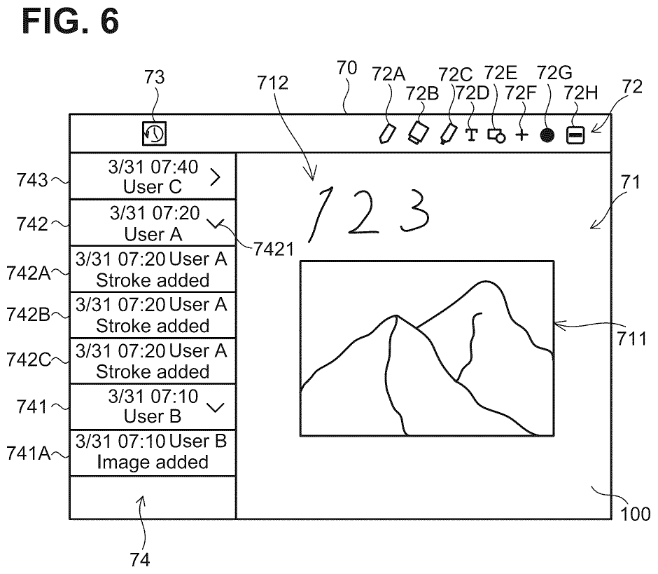

As shown in FIG. 1, the notebook editing system 1 is configured such that the users A, B, and C share a notebook via the server 2 by using the user terminals 3A, 3B, and 3C, respectively. A notebook has one or more page areas 100 (refer to FIG. 6). The page area 100 is configured to be displayed on the display 33. In the note editing system 1, the users A, B, and C can edit objects in the page area 100 by using the user terminals 3A, 3B, and 3C, respectively.

In the present embodiment, the types of objects include strokes, markers, text, shapes, and images. A stroke is a line, such as a straight line or a curved line. A marker is a line for coloring. Text is a string of characters, numerals, symbols, and similar elements arranged in a text block (not shown). A shape is a plane figure or a solid figure. An image is a still image or a moving image. Editing objects can include adding an object, deleting an object, moving an object, changing the font of an object, changing the color of an object, and changing the size of an object.

In the note editing system 1, when a user operates the user terminal 3 through the touch panel 34, the CPU 31 transmits operation information to the server 2. The operation information indicates the details of the performed operation. In the server 2, when the CPU 21 receives the operation information from the user terminal 3, the CPU 21 performs an operation corresponding to the received operation information.

The types of operations performed on the touch panel 34 include a notebook selection operation, a page selection operation, an edit operation, a permission setting change operation, a retention period change operation, a deletion operation, and similar operations. The notebook selection operation is an operation for the user to select a notebook. The page selection operation is an operation for the user to select a page area 100.

The edit operation is an operation for the user to edit an object in the page area 100. The permission setting change operation is an operation for the user to change the permission setting. The retention period change operation is an operation for the user to change the retention period. The delete operation is an operation for the user to delete a history data record.

Operation information corresponding to each of the notebook selection operation, the page selection operation, the edit operation, the permission setting change operation, the retention period change operation, and the deletion operation is referred to as “notebook selection information”, “page selection information”, “edit information”, “permission setting change information”, “retention period change information”, and “deletion information”. Each piece of information indicates information such as the details of each operation and an ID.

For example, when the user performs an edit operation on the user terminal 3, the CPU 31 transmits the edit information to the server 2. When the CPU 21 receives the edit information, the CPU 21 stores the history data record in accordance with the received edit information and updates the notebook. In this case, the CPU 21 transmits the display information to the user terminals 3A to 3C in accordance with the updated notebook. The display information indicates the content displayed in the latest page area 100 (refer to FIG. 6).

When the CPU 31 of each of the user terminals 3A to 3C receives the display information, the CPU 31 displays the content displayed in the latest page area 100 (refer to FIG. 6) based on the received display information. Thus, the content displayed in the page area 100 is shared within the notebook editing system 1 and then displayed on the respective displays 33 of the user terminals 3A to 3C.

### Account Information

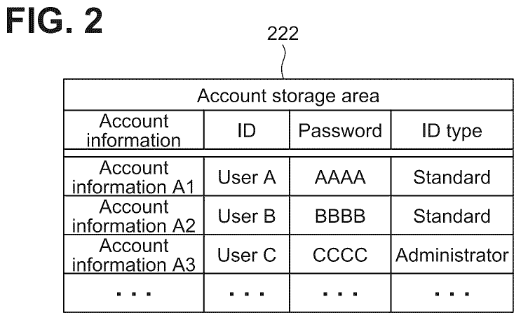

As shown in FIG. 2, account information is stored in the account storage area 222 for each user. In the example shown in FIG. 2, account information A1, account information A2, and account information A3 are stored in the account storage area 222. The account information indicates identification information of the user. In the present embodiment, it indicates an ID, a password, and an ID type.

In the account information, the password and the ID type are associated with the ID of each user. In the example shown in FIG. 2, in the account information A1, the ID “user A” for the user A, the password “AAAA”, and the ID type “standard” are associated with each other. In the account information A2, the ID “user B” for the user B, the password “BBBB”, and the ID type “standard” are associated with each other. In the account information A3, the ID “user C” for the user C, the password “CCCC”, and the ID type “administrator” are associated with each other.

The ID is information used to distinguish one user from another. The password is used to log in the notebook editing system 1. The ID type indicates whether the ID is an administrator ID or a standard ID. In FIG. 2, the administrator ID is indicated by “administrator”, and the standard ID is indicated by “standard”.

The administrator ID is an ID of an administrator user (in this embodiment, user C). The administrator ID is previously authorized to delete history data records from the history storage area 224. Additionally, the administrator ID is previously authorized to determine whether the standard ID has the authority to delete the history data records from the history storage area 224. The standard ID is an ID other than the administrator ID. The standard ID with no permission by the administrator ID is not authorized to delete history data records from the history storage area 224.

In the notebook editing system 1, one or more of IDs are registered in advance as the administrator ID. The administrator ID may be changed later. The standard ID may be further divided into multiple ID types.

### Page Information

Although not shown, the page information is stored in the page storage area 223 (refer to FIG. 1) for each page area 100 in accordance with the corresponding notebook. The page information indicates an object (latest display information) in the page area 100 (refer to FIG. 6), a creator of the page area 100, and other related details.

### History Data Items

As described above, in the notebook editing system 1, multiple users edit an object in the page area 100 in one notebook. The notebook editing system 1 is thus configured such that history data records are stored in the history storage area 224.

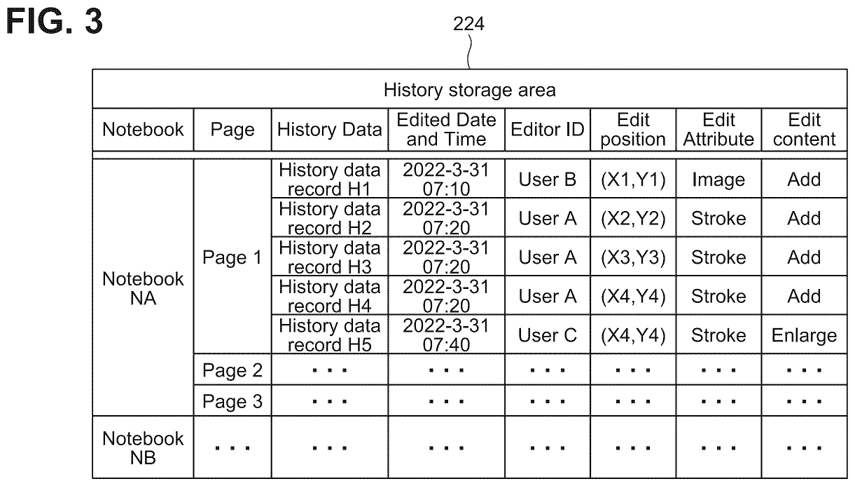

As shown in FIG. 3, history data records are stored in the history storage area 224 for each page area 100 in association with a corresponding notebook. In the present embodiment, a history data record is stored for each edit operation. In the example shown in FIG. 3, history data records H1, H2, H3, H4, and H5 are stored in the history storage area 224 in association with page 1 of the notebook NA.

A history data record indicates a history (referred to as an “edit history”) corresponding to an edit operation. In the present embodiment, it includes an edited date and time, an editor ID, an edit position, an edit attribute, and an edit content. The edited date and time indicates the time when one edit operation is completed. For example, “2022-3-31 07:10” in the history data record H1 indicates that the edit operation corresponding to the history data record H1 has been completed at 7:10, Mar. 31, 2022. The editor ID indicates the ID of a user who performed the edit operation. For example, “user B” in the history data record H1 indicates that the edit operation corresponding to the history data record H1 has been performed by the user B.

The edit position indicates the position of an object edited through an edit operation in the page area 100 (refer to FIG. 6) using coordinate data. For example, “(X1, Y1)” in the history data record H1 indicates that the edit operation corresponding to the history data record H1 has been performed at the position of (X1, Y1) in the page area 100. Although not shown, for example, the origin (0,0) of the coordinates is located at the upper left corner of the page area 100 (refer to FIG. 6). The left-right direction in the page area 100 corresponds to the X-axis direction. The up-down direction in the page area 100 corresponds to the Y-axis direction.

The edit attribute indicates the type of object to be edited. In the present embodiment, the edit attribute is one of a stroke, a marker, a text, a shape, and an image. The term “image” in the history data record H1 in FIG. 3 indicates that the edit operation corresponding to the history data record H1 has been performed on an image.

The edit content indicates changes made to the object. In the present embodiment, the edit content can be either the addition of an object, deletion of an object, movement of an object, change of a font of an object, change of a color of an object, or change of a size of an object (enlargement or reduction). The term “add” in the history data record H1 in FIG. 3 indicates that an object has been added to the page area 100 through the edit operation corresponding to the history data record H1.

### Change Conditions

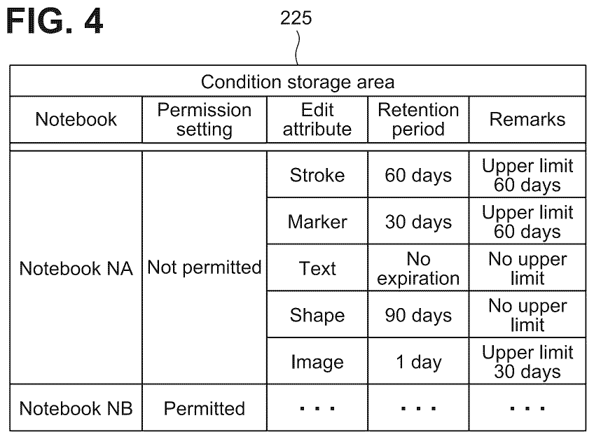

As shown in FIG. 4, the change conditions are conditions required to change the storage states of the history data records. In the present embodiment, the change conditions include the retention period and permission setting. The retention period is set (stored) in a retention period field in the condition storage area 225. The retention period is set in the condition storage area 225 for each edit attribute in association with the corresponding notebook. In the present embodiment, only the administrator user is authorized to change the presence or absence of the retention period and the length of the retention period through the retention period change operation.

The retention period indicates a period for retaining the storage state of a history data record unless the user performs a delete operation. That is, the storage state of the history data record whose retention period has elapsed is not retained. In other words, the storage state of the history data record whose retention period has elapsed is changed. In this embodiment, a history data record whose retention period has elapsed is deleted from the history storage area 224.

In the example shown in FIG. 4, “60 days”, “30 days”, “no expiration”, “90 days”, and “1 day” are set as the retention periods for the edit attributes of the stroke, marker, text, shape, and image, respectively. The term “no expiration” does not mean that a history data record is not stored in the history storage area 224 shown in FIG. 3, but means that the storage state of the history data record is maintained indefinitely if there is no delete operation.

If all the history data records were accumulated in the history storage area 224 and the storage states of the history data records were maintained, the performance of the notebook editing system 1 could be lowered, for example, the operation of the notebook editing system 1 could be slowed down, due to the decreased remaining storage capacity of the history storage area 224. The notebook editing system 1 deletes the history data records whose retention period has elapsed from the history storage area 224, thereby reducing a decrease in the remaining storage capacity of the history storage area 224 and maintaining the performance of the notebook editing system 1.

The upper limit of the retention period that can be set is referred to as “the upper limit of the period” (refer to the remarks field in FIG. 4). The upper limit of the period for stroke is not limited to a specific numerical value, but is set to “60 days” in the present embodiment. The upper limit of the period for marker is not limited to a specific numerical value, but is set to “60 days” in the present embodiment. The upper limit of the period for text is not limited to a specific numerical value, but is set to “no upper limit” in the present embodiment. The upper limit of the period for shape is not limited to a specific numerical value, but is set to “no upper limit” in the present embodiment. The upper limit of the period for image is not limited to a specific numerical value, but is set to “30 days” in the present embodiment.

That is, in the present embodiment, the upper limit of the period for image is shorter than the upper limit of the period for stroke, marker, text, or shape. The upper limit of the period for stroke or marker is shorter than the upper limit of the period for text or shape. The upper limit of the period for text is the same as the upper limit of the period for shape.

When the data capacity per file of the history data is relatively large, the remaining storage capacity of the history storage area 224 is likely to be reduced due to the accumulation of the history data records. In general, the data capacity per file of image is likely to be larger than that of each of stroke, marker, text, or shape. The data capacity per file of each of stroke and marker is likely to be larger than that of each of text and shape. The data capacity per file of each of stroke and marker is comparable. The data capacity per file of each of text and shape is comparable.

As described above, in the present embodiment, the upper limit of the period is set to be shorter for the edit attribute whose data capacity per file is likely to be larger. Thus, setting the upper limit of the period reduces a decrease in the remaining storage capacity of the history storage area 224 due to the accumulation of history data records.

The permission setting is set (stored) in a permission setting field in the condition storage area 225 shown in FIG. 4. The permission setting is set in the condition storage area 225 in association with each notebook. The permission setting indicates whether a user other than the administrator is authorized to change the storage state of a history data record. In the present embodiment, only the administrator is authorized to change the permission setting from “Permitted” to “Not permitted” or vice versa through the permission setting change operation.

In the example shown in FIG. 4, the permission setting “Permitted” indicates that the authority to change the storage state of a history data record is granted to a user other than the administrator, while “Not permitted” indicates that the authority to change the storage state of a history data record is not granted to the user other than the administrator. The permission setting corresponding to the notebook NA shown in FIG. 4 is “Not permitted”. The permission setting corresponding to the notebook NB is “Permitted”.

When the permission setting is “Not permitted”, only the administrator user (the user C in the present embodiment) is authorized to delete a history data record through a delete operation. When the permission setting is “Permitted”, standard users (in this embodiment, user A and user B) are authorized to delete a history data record through a delete operation, as well as the administrator. The change of the retention period and the change of the permission setting are collectively referred to as “history settings”.

### Notebook Selection Window 60

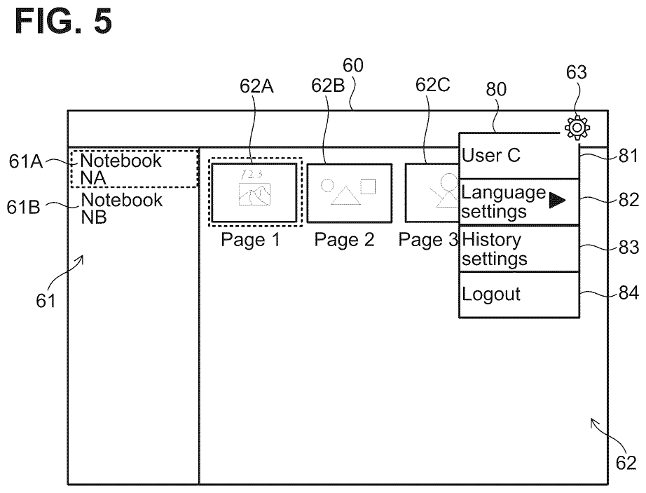

A notebook selection window 60 shown in FIG. 5 is displayed when the user logs in the notebook editing system 1. The notebook selection window 60 includes a notebook selection area 61, a page selection area 62, and a settings button 63. The notebook selection area 61 displays one or more options. An option indicates a notebook that has already been created. In the example shown in FIG. 5, the options 61A and 61B indicating the notebook NA and the notebook NB are displayed in the notebook selection area 61.

The page selection area 62 displays thumbnails each corresponding to a page area 100 (refer to FIG. 6). In the example shown in FIG. 5, thumbnails 62A, 62B, and 62C are displayed in the page selection area 62. The thumbnail 62A corresponds to the page area 100 (refer to FIG. 6) of the first page of the notebook NA. The thumbnail 62B corresponds to a page area of the second page of the notebook NA. The thumbnail 62C corresponds to a page area of the third page of the notebook NA. The settings button 63 is selected when the history settings are performed.

An example of a notebook selection operation will be described. For example, the user selects an option in the notebook selection area 61. That is, the user selects a notebook. When the notebook selection area 61 displays a single notebook only, the user selects that notebook. When the notebook selection area 61 displays multiple notebooks, the user selects one from the notebooks. In the example shown in FIG. 5, a state where the option 61A is selected is indicated by a broken line.

An example of a page selection operation will be described. For example, the user selects a thumbnail in the page selection area 62. In this way, the user selects a page area 100 corresponding to the selected thumbnail.

### Setting Selection Window 80

A setting selection window 80 shown in FIG. 5 is displayed when the settings button 63 is selected. The setting selection window 80 includes an ID display area 81, a language settings area 82, a history settings area 83, and a logout button 84. The ID display area 81 displays the ID of the user. In the example shown in FIG. 5, the administrator ID “user C” is displayed in the ID display area 81. The language settings area 82 is selected when the language is switched.

The history settings area 83 is selected when history settings are performed. The history settings area 83 is displayed in the setting selection window 80 and is selectable only when the user is logged in with the administrator ID (for example, user C). That is, when the user is logged in with a standard ID (for example, user A or user B), the history settings area 83 is not displayed in the setting selection window 80 or cannot be selected. The logout button 84 is selected when the user logs out of the notebook editing system 1.

### Page Editing Window 70

A page editing window 70 shown in FIG. 6 is displayed when the thumbnail 62A is selected in the page selection area 62 shown in FIG. 5. The page editing window 70 includes a main area 71, a plurality of edit buttons 72, a history button 73, and a history display area 74. The main area 71 displays one or more page areas 100 selected through the page selection operation. In the example shown in FIG. 6, the page area 100 includes objects 711 and 712. The object 711 is a single image on which a mountain is drawn. The object 712 has three strokes in the shape of “123”.

The plurality of edit buttons 72 are selectable when an object in the page area 100 is to be edited. In the example shown in FIG. 6, the plurality of edit buttons 72 include buttons 72A, 72B, 72C, 72D, 72E, 72F, 72G, and 72H.

The button 72A is selected when a stroke is to be added within the page area 100. The button 72B is selected when an object is to be deleted from the page area 100. The button 72C is selected when a marker is to be added within the page area 100. The button 72D is selected when text is to be added within the page area 100.

The button 72E is selected when a shape is to be added within the page area 100. The button 72F is selected when an image is to be added within the page area 100. The button 72G is selected when the color of stroke, text, or shape within the page area 100 is to be changed. The button 72H is selected when the thickness of a stroke within the page area 100 is to be changed.

The history button 73 is selected when the history display area 74 is toggled between visible and hidden in the page editing window 70. FIG. 6 shows an example of the page editing window 70 in a state where the history button 73 is selected and the history display area 74 is displayed.

The history display area 74 displays edit history groups or a list of edit histories. An edit history group consists of one or more of multiple edit histories organized by user, edited date and time, edit attribute, and similar criteria. In the example shown in FIG. 6, the history display area 74 displays edit history groups 741, 742, and 743 and edit histories 741A, 742A, 742B, and 742C. For example, the edit history group 742 provides a summary of edit histories corresponding to the edited date and time “3/31 07:20” and the editor ID “user A”. When an expansion mark 7421 is selected on the edit history group 742, the edit histories 742A, 742B, and 742C are developed or expanded.

An example of an edit operation will be described. For example, to add an object 711 within the page area 100, the user selects the button 72F. The user selects an image file representing the object 711. The user selects a position in the page area 100 where the object 711 is to be added. The object 711 is thus added to the page area 100.

An example of an edit operation will be described. For example, to add an object 712 within the page area 100, the user selects the button 72A. The user draws strokes in the shape of “123” in the page area 100 as the object 712 to be added. The object 712 is thus added within the page area 100.

An example of a delete operation will be described. For example, to delete a history data record corresponding to the edit history 742A, the user selects the history button 73. The history display area 74 is thus displayed. The user selects the expansion mark 7421. The edit history 742A is thus shown. The user selects the edit history 742A. The user selects a delete button (not shown). The history data record corresponding to the edit history 742A is thus deleted.

### History Settings Window 90

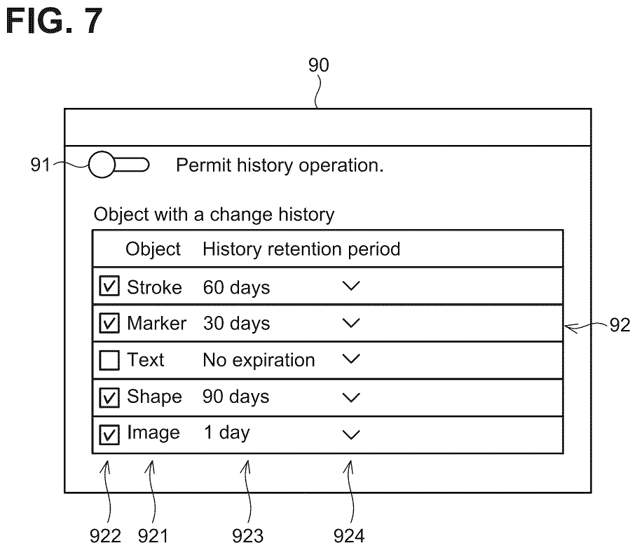

A history settings window 90 shown in FIG. 7 is displayed when the history settings area 83 shown in FIG. 5 is selected. The history settings window 90 includes a permission setting switching button 91 and a retention period setting area 92.

The permission setting switching button 91 indicates whether the permission setting is “Permitted” or “Not permitted”. In the present embodiment, when the permission setting switching button 91 is positioned on the left side, it indicates that the permission setting is “Not permitted”, and when the permission setting switching button 91 is positioned on the right side, it indicates that the permission setting is “Permitted”. The permission setting switching button 91 is operated when the permission setting is switched from “Permitted” to “Not permitted” or vice versa.

The retention period setting area 92 displays information relating to settings of retention periods, and includes, in the present embodiment, an edit attribute display area 921, check boxes 922, a retention period display area 923, and pull-down marks 924. The edit attribute display area 921 displays edit attributes. In this embodiment, the edit attribute display area 921 displays object names as the edit attributes, and lists terms, stroke, marker, text, shape, and image in the descending order from the upper side to the lower side.

The check boxes 922 are provided so as to correspond to the object names listed in the edit attribute display area 921. A check box 922 is selected when a retention period is changed from a default retention period or returned to the default retention period. The default retention period is stored in the ROM 22A shown in FIG. 1. The default retention period may be the upper limit of the period for each edit attribute, may be shorter than the upper limit of the period for each edit attribute, or may be set to “no expiration”.

In the example shown in FIG. 7, the check box 922 corresponding to text is not checked, and the check boxes 922 corresponding to stroke, marker, shape, and image are checked. This means that the retention period for text is set to its default, while the retention periods for stroke, marker, shape, and image have been changed from their defaults.

The retention period display area 923 is provided so as to correspond to the edit attribute display area 921 and displays the retention periods that are set in accordance with the edit attributes. In the example shown in FIG. 7, “60 days”, “30 days”, “no expiration”, “90 days”, and “1 day” are set as the retention periods for stroke, marker, text, shape, and image, respectively. The pull-down marks 924 are provided so as to correspond to the retention periods listed in the retention period display area 923. A pull-down mark 924 is selected when a retention period is changed.

### Main Process

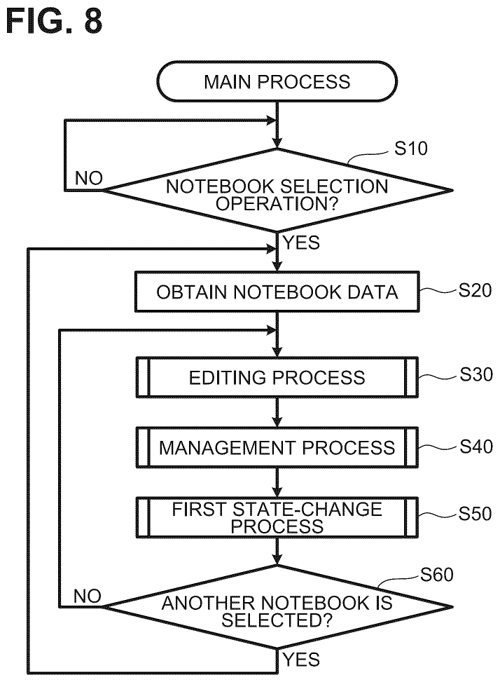

When the user logs in the notebook editing system 1, the CPU 21 shown in FIG. 1 reads out the control program from the program storage area 221 shown in FIG. 1. The CPU 21 executes the read control program to start a main process shown in FIG. 8. The main process will be described primarily in terms of control related to the processing of history data records. The control related to the sharing of notebooks by multiple users will not be shown and described.

In the present embodiment, when a user logs into the notebook editing system 1, the CPU 31 transmits the login information to the server 2. The login information includes information such as an ID and a password. Even when multiple users are simultaneously logged into the notebook editing system 1, the CPU 31 is configured to identify each user who has performed an operation based on the login information.

When the main process starts, the CPU 21 determines whether a notebook selection operation has been performed based on whether the CPU 21 has received notebook selection information from the user terminal 3 (S10). In this embodiment, when the user performs a notebook selection operation in the notebook selection window 60 shown in FIG. 5, the CPU 31 transmits notebook selection information to the server 2. The notebook selection information includes information for specifying the notebook selected by the user.

When the CPU 21 has not received the notebook selection information from the user terminal 3, it determines that the notebook selection operation is not performed (S10: NO). In this case, the CPU 21 returns the process to step S10 for determination. When the CPU 21 has received the notebook selection information from the user terminal 3, it determines that the notebook selection operation is performed (S10: YES). In this case, the CPU 21 obtains notebook data corresponding to the selected notebook from the flash memory 22C shown in FIG. 1 based on the notebook selection information (S20).

The CPU 21 performs an editing process (S30). In the editing process, the CPU 21 edits objects in the page area 100 (refer to FIG. 6), and stores history data records in the history storage area 224 shown in FIG. 3 in accordance with the edit operations. The CPU 21 performs a management process (S40). In the management process, the CPU 21 changes the change condition of the storage state of a history data record in the condition storage area 225 based on the permission setting change operation or the retention period change operation, and deletes the history data record based on the retention period. The CPU 21 performs a first state change process (S50). In the first state change process, the CPU 21 deletes a history data record from the history storage area 224 based on the delete operation.

The CPU 21 determines whether a notebook selection operation for selecting another notebook has been performed based on notebook selection information transmitted from the user terminal 3 (S60). Another notebook refers to a notebook different from the one selected in the process in step S10.

When no notebook selection operation for selecting another notebook is performed (S60: NO), the CPU 21 returns the process to step S30. In this case, the CPU 21 repeats steps S30, S40, and S50 for the selected notebook.

When a notebook selection operation for selecting another notebook is performed (S60: YES), the CPU 21 returns the process to step S20. In this case, the CPU 21 obtains notebook data corresponding to another notebook from the flash memory 22C shown in FIG. 1 (S20), and performs steps S30, S40, and S50 in relation to another notebook.

### Editing Process

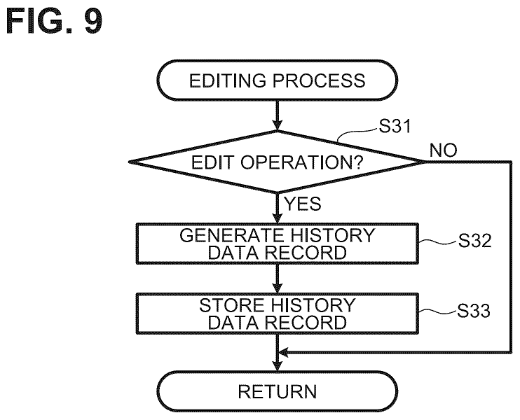

As shown in FIG. 9, when the editing process starts, the CPU 21 determines whether an edit operation has been performed based on whether the CPU 21 has received edit information from the user terminal 3 (S31). In this embodiment, when the user performs an edit operation in the page editing window 70 shown in FIG. 6, the CPU 31 transmits edit information to the server 2. The edit information indicates an edit content and includes information for generating a history data record.

When the CPU 21 has not received the edit information from the user terminal 3, the CPU 21 determines that an edit operation is not performed (S31: NO). In this case, the CPU 21 returns the process to the main process shown in FIG. 8. When the CPU 21 has received the edit information from the user terminal 3, the CPU 21 determines that an edit operation is performed (S31: YES). In this case, the CPU 21 generates a history data record based on the edit information (S32).

In step S32, for example, the CPU 21 obtains the time at which it received the edit information from a real-time clock (not shown), and sets this time as the edited date and time. The CPU 21 sets an ID indicated by the edit information as an editor ID. The CPU 21 specifies an edit attribute and an edit position based on the edit content in the edit information. The CPU 21 stores the generated history data record in association with the corresponding notebook page in the history storage area 224 (S33). In this case, the CPU 21 stores the generated history data record in the history storage area 224 to accumulate history data records, rather than overwriting the already stored history data records. The CPU 21 returns the process to the main process shown in FIG. 8.

### Management Process

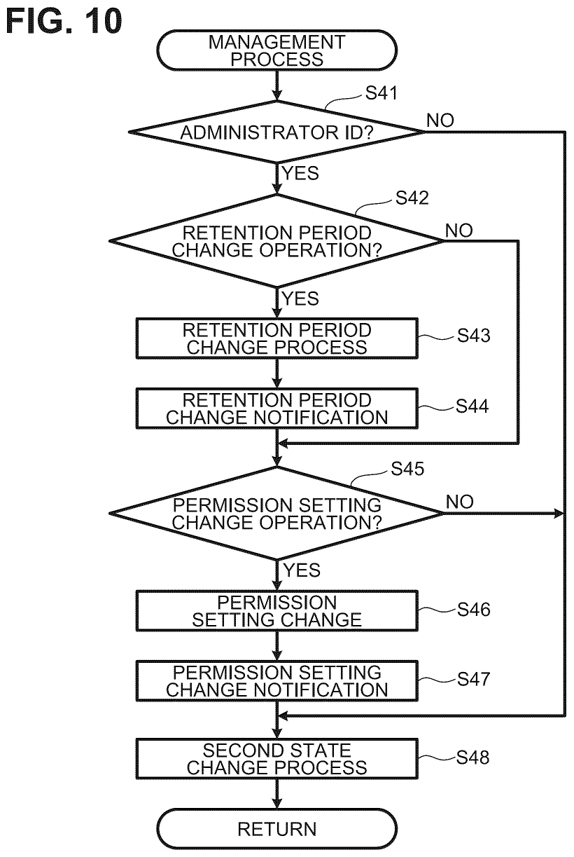

As shown in FIG. 10, when the management process starts, the CPU 21 refers to the account storage area 222 shown in FIG. 2 to determine whether a logged-in ID is the administrator ID (in this embodiment, the ID of the user C) (S41). When the logged-in ID is not the administrator ID (S41: NO), the CPU 21 shifts the process to step S48.

When the logged-in ID is the administrator ID (S41: YES), the CPU 21 determines whether a retention period change operation has been performed based on whether the CPU 21 has received retention period change information from the user terminal 3 (S42). In this embodiment, when the user performs a retention period change operation in the history settings window 90 shown in FIG. 7, the CPU 31 transmits retention period change information to the server 2. The retention period change information includes information for specifying an edit attribute whose retention period has been changed and a retention period after the change.

When the CPU 21 has not received the retention period change information from the user terminal 3, the CPU 21 determines that a retention period change operation is not performed (S42: NO). In this case, the CPU 21 returns the process to step S45 for determination. When the CPU 21 has received the retention period change information from the user terminal 3, the CPU 21 determines that a retention period change operation is performed (S42: YES). In this case, the CPU 21 performs a retention period change process (S43). In the retention period change process, the CPU 21 stores the changed retention period in the retention period field corresponding to the edit attribute in the condition storage area 225 shown in FIG. 4, based on the retention period change information.

The CPU 21 transmits a retention period change notification to the user terminal 3 of the standard user who is currently logged in (S44). For the standard user who is logged out, the CPU 21 transmits a retention period change notification to the user terminal 3 at the next login. The retention period change notification indicates the content of the change of the retention period. The retention period change notification may state, for example, “the retention period of the history data for image has been changed from 30 days to 1 day”.

If the retention period change notification is not notified to the standard user, the standard user cannot be aware of the change in the retention period. In the present embodiment, since the retention period change notification is transmitted to the user terminal 3 of the standard user, the standard user can easily understand whether the retention period has been changed and what the change entails.

The CPU 21 determines whether a permission setting change operation has been performed based on whether the CPU 21 has received permission setting change information from the user terminal 3 (S45). In this embodiment, when the user performs a permission setting change operation in the history settings window 90 shown in FIG. 7, the CPU 31 transmits permission setting change information to the server 2. The permission setting change information includes information for specifying a permission setting after the change.

When the CPU 21 has not received the permission setting change information from the user terminal 3, the CPU 21 determines that the permission setting change operation is not performed (S45: NO). In this case, the CPU 21 shifts the process to the process of S48. When the CPU 21 has received the permission setting change information from the user terminal 3, the CPU 21 determines that the permission setting change operation is performed (S45: YES). In this case, the CPU 21 stores the changed permission setting in the area of the permission setting corresponding to the selected notebook in the condition storage area 225 shown in FIG. 4, based on the permission setting change information (S46).

The CPU 21 transmits a permission setting change notification to the user terminal 3 of the standard user who is currently logged in (S47). For the standard user who is logged out, the CPU 21 transmits a permission setting change notification to the user terminal 3 at the next login. The permission setting change notification indicates the content of the permission setting change. The permission setting change notification may state, for example, “Standard user is permitted to delete history data” or “Standard user is not permitted to delete history data”.

If the permission setting change notification is not notified to the standard user, the standard user may not be aware of the permission setting change. In the present embodiment, since the permission setting change notification is transmitted to the user terminal 3 of the standard user, the standard user can easily understand whether the permission setting has been changed and what the change entails.

The CPU 21 performs a second state change process (S48). The CPU 21 returns the process to the main process shown in FIG. 8. In the second state change process, the CPU 21 deletes a history data record whose retention period has elapsed from the history storage area 224. For example, the CPU 21 reads the condition storage area 225 shown in FIG. 4, and specifies the retention period for a particular edit attribute. The CPU 21 refers to the edited date and time corresponding to the particular edit attribute in the history storage area 224 shown in FIG. 3. The CPU 21 identifies a history data record whose retention period has elapsed since it was stored in the history storage area 224, among history data records for the particular edit attribute. The CPU 21 deletes the identified history data record from the history storage area 224 shown in FIG. 3. Similarly, the CPU 21 deletes an identified history data record from the history storage area 224 for a further edit attribute in the same manner as for the particular edit attribute.

In the example shown in FIG. 3, the particular edit attribute is image, and the further other edit attribute is stroke. The current time is set to one day after the edited date and time, which is 7:10 on Mar. 31, 2022. In this case, the CPU 21 identifies the history data record H1 as a history data record for which one day has elapsed since it was stored in the history storage area 224, among history data records for image. The CPU 21 deletes the history data record H1 from the history storage area 224.

At the time when one day has passed since 7:10 on Mar. 31, 2022, there is no history data record for stroke for which 90 days have passed since the history data record was stored in the history storage area 224. In this case, the CPU 21 does not delete the history data records H2 to H5 corresponding to stroke from the history storage area 224, and maintains the storage states of the history data records H2 to H5.

For example, “one day has elapsed” may mean that 24 hours have elapsed since the history data record was stored in the history storage area 224, or that the reference time (e.g., 0:00) of the next day has elapsed from the day the history data record was stored in the history storage area 224. Further, the phrase “when the retention period has elapsed” may mean the time when the retention period has elapsed or any time after the retention period has elapsed.

### First State Change Process

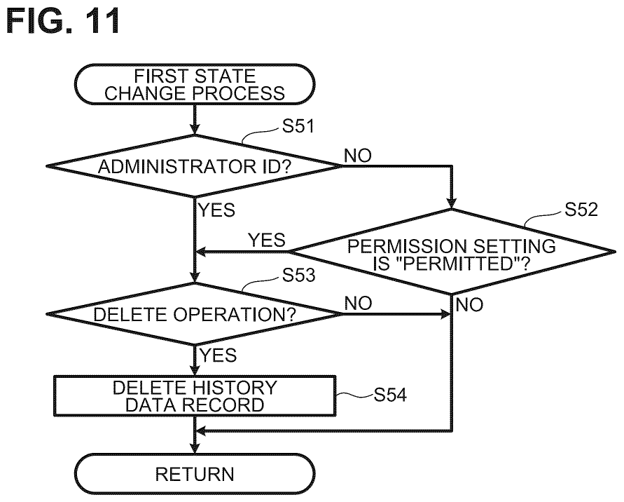

As shown in FIG. 11, when the first state change process starts, the CPU 21 refers to the account storage area 222 shown in FIG. 2 to determine whether a logged-in ID is the administrator ID (S51). When the logged-in ID is the administrator ID (S51: YES), the CPU 21 shifts the process to step S53 for determination. In the example shown in FIG. 2, when the user C is logged in, the ID type is “administrator”, and thus the CPU 21 determines that the logged-in ID is the administrator ID.

When the logged-in ID is not the administrator ID (S51: NO), the CPU 21 shifts the process to step S52 for determination. In the example shown in FIG. 2, when the user A or the user B is logged in, the ID type is “standard”, and thus the CPU 21 determines that the logged-in ID is not the administrator ID.

The CPU 21 refers to the condition storage area 225 to determine whether the permission setting is “Permitted” (S52). When the permission setting is “Not permitted” (S52: NO), the CPU 21 returns the process to the main process shown in FIG. 8.

When the permission setting is “Permitted” (S52: YES), the CPU 21 determines whether a delete operation has been performed based on whether the CPU 21 has received deletion information from the user terminal 3 (S53). In this embodiment, when the user performs a delete operation in the history display area 74 shown in FIG. 6, the CPU 31 transmits deletion information to the server 2. The deletion information includes information for specifying a target history data record to be deleted.

When the CPU 21 has not received the deletion information, the CPU 21 determines that the delete operation is not performed (S53: NO). In this case, the CPU 21 returns the process to the main process shown in FIG. 8.

When the CPU 21 has received the deletion information, the CPU 21 determines that the delete operation is performed (S53: YES). In this case, the CPU 21 deletes a target history data record from the history storage area 224 based on the deletion information (S54). The CPU 21 returns the process to the main process shown in FIG. 8.

### Effects of the Embodiment

In the above embodiment, when the user performs a retention period change operation or permission setting change operation, the change condition of the storage state of the history data record is changed in the process in step S43 or S46. The process in step S43 or S46 thus allows the user to easily manage the storage states of history data records.

For example, there may be an edit attribute of a history data item that the user desires to delete in a short period of time, and an edit attribute of a history data item that the user desires to maintain its storage state for a long period of time. If the retention period is the same for all the edit attributes, retaining the storage state of the history data record for a period desired by the user for each edit attribute may become difficult. For example, if a history data record is deleted sooner than the user desires, the user may find it difficult to confirm the history data record and restore the history. For example, if the storage state of a history data record is maintained for a period longer than the user desires, the performance of the notebook editing system 1 may be lowered due to the decreased remaining storage capacity of the history storage area 224. Additionally, an increase in the number of history data records may make it difficult for the user to manage the pieces of history data. In the above embodiment, in the process in step S43, the retention period is changed in accordance with the edit attribute of a history data record. The process in step S43 thus allows the user to easily manage the retention period in accordance with the edit attribute.

In the process in step S43, the retention period for history data records for stroke or marker may be changed to have no upper limit. In the process in step S43, the retention period for history data records for text or shape may be changed to within 90 days. In the process in step S43, the retention period for history data records for image may be changed to within 30 days. That is, in the process in step S43, the upper limit of the retention period varies according to each edit attribute. The process in step S43 thus allows retention periods to be set within different time limits according to the edit attributes.

In the process in step S48, a history data record whose retention period has elapsed is deleted from the history storage area 224. The process in step S48 can thus reduce a decrease in the remaining storage capacity of the history storage area 224 due to the accumulation of history data records.

When the permission setting is “Permitted”, a history data record is deleted from the history storage area 224 by the user A or the user B in the process in step S54. That is, the storage state of the history data record is changed by the “Standard” user. When the permission setting is “Not permitted”, a history data record is not deleted from the history storage area 224 by the user A or the user B in the process in step S54. That is, the delete operation by the “Standard” user is not accepted, and the storage state of the history data record remains unchanged by the “Standard” user. The permission setting is changed through the process in step S46 when the user C, that is, the administrator user, performs the permission setting changing operation. The process in step S46 can thus reduce the likelihood of the standard user deleting a history data record from the history storage area 224, contrary to the intentions of the administrator user.

### Correspondence Between Embodiment and Disclosure

In the above embodiment, the display 33 corresponds to a “display” of the present disclosure. The page area 100 corresponds to an “area” of the present disclosure. The notebook editing system 1 corresponds to an “information editing system” of the present disclosure. The CPU 21 corresponds to a “computer” of the present disclosure. The process in S33 corresponds to “storing a history data record” of the present disclosure. The process in S43 and the process in S46 correspond to “changing a change condition” of the present disclosure. The permission setting change operation or the retention period change operation corresponds to a “condition change operation” of the present disclosure.

The edit attribute corresponds to an “attribute” of the present disclosure. The retention period corresponds to a “retention period” of the present disclosure. For example, edit attribute “stroke” corresponds to a “first attribute” of the present disclosure. For example, 60 days corresponds to a “first retention period” of the present disclosure. For example, edit attribute “image” corresponds to a “second attribute” of the present disclosure. For example, 30 days corresponds to a “second retention period” of the present disclosure. The process in S48 corresponds to “deleting a history data record” of the present disclosure.

The administrator ID corresponds to a “first ID” of the present disclosure. The user terminal 3C corresponds to a “first terminal” of the present disclosure. The touch panel 34 of the user terminal 3C corresponds to a “first operation unit” of the present disclosure. The standard ID corresponds to a “second ID” of the present disclosure. The user terminal 3A or 3B corresponds to a “second terminal” of the present disclosure. The touch panel 34 of the user terminal 3A or the touch panel 34 of the user terminal 3B corresponds to a “second operation unit” of the present disclosure. The process in S41 corresponds to “determining whether an ID logged into the information editing system is the first ID” of the present disclosure. The process in S54 corresponds to “changing a storage state of the history data record” of the present disclosure. The delete operation corresponds to a “state change operation” of the present disclosure.

### Modifications

The present disclosure may be variously modified from the above embodiment. For example, in the above embodiment, the user terminal 3 is not limited to a tablet terminal, but may be a smartphone, a personal computer, a dedicated terminal, or other devices. The user terminal 3 may include a mouse and a keyboard, instead of or in addition to the touch panel 34.

In the above embodiment, the notebook editing system 1 includes the server 2 and the user terminals 3. In contrast, the notebook editing system 1 may include the server 2 and a single user terminal 3. That is, the notebook editing system 1 does not need to be configured for multiple users to share a notebook. In this case, the notebook editing system 1 may be configured with a single user terminal 3 without including the server 2. When the notebook editing system 1 is configured with a single user terminal 3, the CPU 31 may execute the main process. In this case, the condition storage area 225 does not need to store the permission settings, and the CPU 31 may skip the processes in steps S41, S44, S45, S46, S47, S51, and S52.

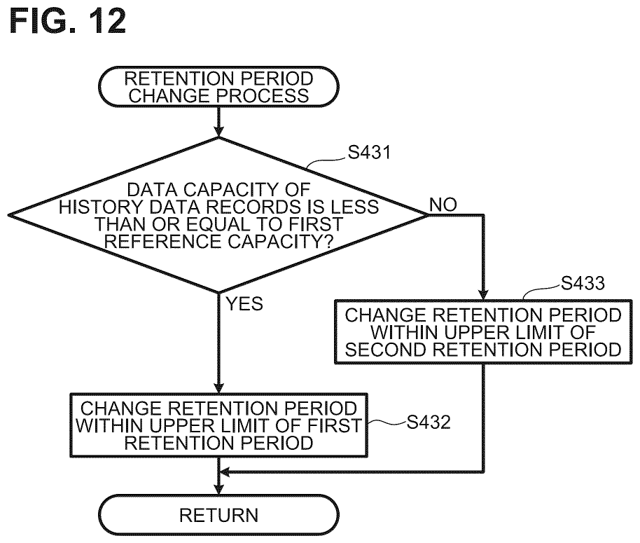

In the above embodiment, the notebook editing system 1 may change the details of the retention period change process in step S43. For example, as shown in FIG. 12, when the retention period change process starts, the CPU 21 determines whether the data capacity of history data records for an edit attribute for which the retention period change operation is performed is less than or equal to a first reference capacity based on the retention period change information (S431). The first reference capacity is a predetermined threshold value, and is stored in advance in the ROM 22A shown in FIG. 1. The first reference capacity may be set based on, for example, the storage capacity of the history storage area 224.

The data capacity of history data records for the edit attribute for which the retention period change operation is performed may refer to: the overall data capacity of history data records for the edit attribute for which the retention period change operation is performed; or the individual data capacities of history data records for the edit attribute for which the retention period change operation is performed.

When the data capacity of history data records for the edit attribute for which the retention period change operation is performed is less than or equal to the first reference capacity (S431: YES), the CPU 21 changes the retention period within an upper limit of a first retention period (S432). The CPU 21 returns the process to the management process shown in FIG. 10.

When the data capacity of history data records for the edit attribute for which the retention period change operation is performed is greater than the first reference capacity (S431: NO), the CPU 21 changes the retention period within an upper limit of a second retention period (S433). The upper limit of the second retention period is shorter than the upper limit of the first retention period. The CPU 21 returns the process to the management process shown in FIG. 10. The retention period is configured so that the storage state of the history data record is retained for a predetermined period after the history data record is stored in the process in step S33. Thus, the history data record is not deleted immediately after it is stored in the process in step S33.

According to the retention period change process shown in FIG. 12, when the data capacity of history data records is greater than the first reference capacity, the retention period is set within the upper limit of the second retention period. In this case, even if the longest period is set as the retention period, the retention period is shorter than the upper limit of the first retention period. The retention period change process can thus reduce a decrease in the remaining storage capacity of the history storage area 224 due to the accumulation of history data records, as compared with a case where the upper limit of the first retention period is set as the retention period regardless of the size of the data capacity of history data records. In this case, the process in step S431 corresponds to the “capacity determination process” of the present disclosure.

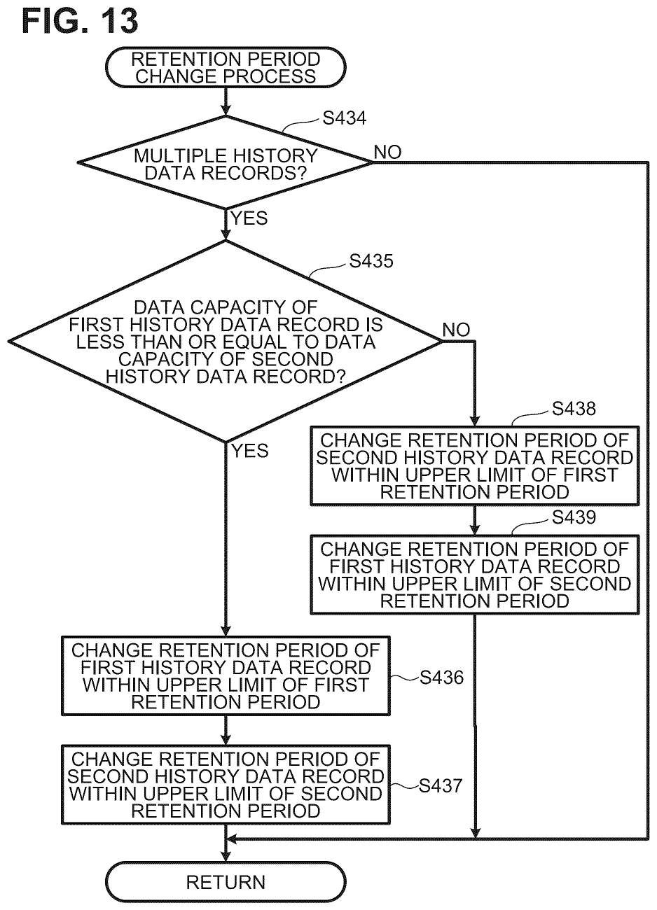

For example, as shown in FIG. 13, when the retention period change process starts, the CPU 21 determines whether there are multiple history data records in which the retention period change operation has been performed (S434). The history data records for which the retention period change operation has been performed include “first history data record” and “second history data record”. The first history data record and the second history data record do not have to belong to the same edit attribute. The first history data record and the second history data record may be defined as history data records belonging to the same edit attribute.

When the first history data record and the second history data record do not exist (S434: NO), the CPU 21 returns the process to the management process shown in FIG. 10. That is, when only one history data record exists, the CPU 21 does not change the retention period for the history data record. This means that, for example, when one history data record is stored, the retention period for the stored history data record is not changed. The retention period is configured so that the storage state of the history data record is retained for a predetermined period after the history data record is stored in the process in step S33. Thus, the history data record is not deleted immediately after it is stored in the process in step S33. When the first history data record and the second history data record exist (S434: YES), the CPU 21 compares the data capacity of the first history data record with the data capacity of the second history data record, and determines whether the data capacity of the first history data record is less than or equal to the data capacity of the second history data (S435).

When the data capacity of the first history data record is less than or equal to the data capacity of the second history data record (S435: YES), the CPU 21 changes the retention period of the first history data record within the upper limit of the first retention period (S436). The CPU 21 changes the retention period of the second history data record within the upper limit of the second retention period (S437). The CPU 21 returns the process to the management process shown in FIG. 10.

When the data capacity of the first history data record is greater than the data capacity of the second history data record (S435: NO), the CPU 21 changes the retention period of the second history data record within the upper limit of the first retention period (S438). The CPU 21 changes the retention period of the first history data record within the upper limit of the second retention period (S439). The CPU 21 returns the process to the management process shown in FIG. 10.

That is, the CPU 21 may change the retention period of either the first history data record or the second history data record, whichever has the smaller data capacity, within the upper limit of the first retention period based on the comparison result in the process in step S435. The CPU 21 may change the retention period of either the first history data record or the second history data record, whichever has the greater data capacity, within the upper limit of the second retention period based on the comparison result in the process in step S435. When the data capacity of the first history data record and the data capacity of the second history data record are equal to each other, the CPU 21 may change the retention period for the first history data record within the upper limit of the first retention period and change the retention period for the second history data record within the upper limit of the second retention period.

As a result, the retention period of either the first history data record or the second history data record, whichever has the greater data capacity, is set within the upper limit of the second retention period. In this case, even if the longest period is set as the retention period, the retention period is shorter than the upper limit of the first retention period. The retention period change process can thus reduce a decrease in the remaining storage capacity of the history storage area 224 due to the accumulation of history data records, as compared with a case where the upper limit of the first retention period is set as the retention period regardless of the size of the data capacity of history data records. In this case, the process in step S435 corresponds to the “capacity comparison process” of the present disclosure.

The CPU 21 may perform the process in step S431 when the number of history data records reaches a predetermined number or when the total of the data capacities of the multiple history data records reaches a predetermined capacity. In this case, the CPU 21 may rank the history data records according to a predetermined rule such as the order of data capacity or the order of edited date and time. Furthermore, the CPU 21 may change the retention period within the upper limit of the first retention period for the ranked history data records higher than the predetermined order, and may change the retention period within the upper limit of the second retention period for the ranked history data lower than the predetermined order.

In the above embodiment, “the change of the storage state of the history data record” means deletion of the history data record. In contrast, “the change of the storage state of the history data record” may also mean a reduction in the data capacity of history data records. For example, the CPU 21 may reduce the data capacity of a history data record whose retention period has elapsed in the second state change process in step S48. This reduction can be achieved through methods, such as compression, lowering of the resolution of the image, or thinning of dots included in the stroke. The amount of data capacity reduction is not limited to a specific amount or percentage. The second state change process can thus reduce a decrease in the remaining storage capacity of the history storage area 224 due to the accumulation of history data records. In this case, the process in step S48 corresponds to a “reduction process” of the present disclosure.

Furthermore, when the permission setting is “Permitted”, a standard user may be authorized to reduce the data capacity of a history data record through a reduction operation, as well as the administrator user. In this case, in the process in step S53, the CPU 21 may determine whether a reduction operation has been performed instead of or in addition to determining whether a delete operation has been performed. When the reduction operation is performed, the CPU 21 may reduce the data capacity of history data records. The reduction operation is an operation for reducing the history data records. The reduction operation is, for example, an operation of selecting a reduction button (not shown) instead of a deletion button among delete operations. In this case, the reduction operation corresponds to a “state change process” of the present disclosure.

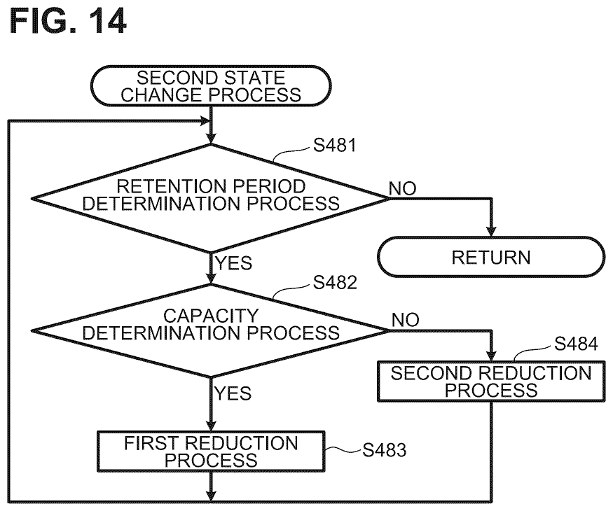

In the above embodiment, the notebook editing system 1 may change the details of the second state change process. For example, as shown in FIG. 14, when the second state change process starts, the CPU 21 performs a retention period determination process (S481). In the retention period determination process, the CPU 21 refers to the history storage area 224 to determine whether there is a history data record whose retention period has elapsed. When a history data record whose retention period has elapsed does not exist (S481: NO), the CPU 21 returns the process to the management process shown in FIG. 10.

When a history data record whose retention period has elapsed exists (S481: YES), the CPU 21 performs a capacity determination process (S482). In the capacity determination process, the CPU 21 determines whether the data capacity of history data records whose retention period has elapsed is less than or equal to a second reference capacity. The second reference capacity is a predetermined threshold value, and is stored in advance in the ROM 22A shown in FIG. 1. The second reference capacity may be set based on, for example, the storage capacity of the history storage area 224.

When the data capacity of history data records whose retention period has elapsed is less than or equal to the second reference capacity (S482: YES), the CPU 21 performs a first reduction process (S483). In the first reduction process, the CPU 21 reduces the data capacity of history data records whose retention time has elapsed by a first specified percentage. When the data capacity of history data records whose retention period has elapsed is greater than or equal to the second reference capacity (S482: NO), the CPU 21 performs a second reduction process (S484). In the second reduction process, the CPU 21 reduces the data capacity of history data records whose retention time has elapsed by a second specified percentage. The second specified percentage is greater than the first specified percentage. The first specified percentage and the second specified percentage are predetermined values, and are stored in advance in the ROM 22A shown in FIG. 1.

According to the second state change process shown in FIG. 14, when the data capacity of history data records is greater than the second reference capacity, the data capacity of history data records whose retention period has elapsed is reduced by a percentage greater than the first specified percentage. The second state change process can thus reduce a decrease in the remaining storage capacity due to the accumulation of history data records, as compared with a case where the reduction is performed by the first specified percentage regardless of the size of the data capacity of history data records. In this case, the process in step S482 corresponds to a “capacity determination process” of the present disclosure.

In the second state change process shown in FIG. 14, the CPU 21 may change the details of the retention period determination process in S481. For example, in the retention period determination process in S481, the CPU 21 may determine whether there are a plurality of history data records whose retention period has elapsed. The plurality of history data records whose retention period has elapsed include a “first history data record” and a “second history data record”. When history data records whose retention period has elapsed do not exist (S481: NO), the CPU 21 returns the process to the management process shown in FIG. 10. When the history data records whose retention period has elapsed exist (S481: YES), the CPU 21 may compare the data capacity of the first history data record with the data capacity of the second history data record, and determine whether the data capacity of the first history data record is less than or equal to the data capacity of the second history data in a capacity determination process in step S482.

When the data capacity of the first history data record is less than or equal to that of the second history data record (S482: YES), the CPU 21 may, in the first reduction process in S483, reduce the data capacity of the first history data record by the first specified percentage and reduce the data capacity of the second history data record by the second specified percentage. When the data capacity of the first history data record is greater than that of the second history data record (S482: NO), the CPU 21 may, in the second reduction process in S484, reduce the data capacity of the second history data record by the first specified percentage and reduce the data capacity of the first history data record by the second specified percentage.

That is, based on the comparison result in the capacity determination process in step S482, the CPU 21 may reduce, by the first specified percentage, the smaller data capacity of either the first history data record or the second history data record and reduce, by the second specified percentage, the greater data capacity of either the first history data record or the second history data record. When the data capacity of the first history data record and the data capacity of the second history data record are equal to each other, the CPU 21 may reduce the data capacity of the first history data record by the first specified percentage and the data capacity of the second history data record by the second specified percentage.

As a result, the greater data capacity of either the first history data record or the second history data record is reduced by a percentage greater than the first specified percentage. The second state change process can thus reduce a decrease in the remaining storage capacity due to the accumulation of history data records, as compared with a case where the reduction is performed by the first specified percentage regardless of the size of the data capacity of history data records. In this case, the process in step S482 corresponds to a “capacity comparison process” of the present disclosure.

The upper limit of the period for each edit attribute is not limited to the above-described embodiment. For example, the upper limit of the period may be set differently or the same for each edit attribute, regardless of whether the edit attribute tends to increase the data capacity per file. More specifically, the upper limit of the period for image may be longer than or equal to any or all of the upper limits of the periods for stroke, marker, text, and shape. The upper limit of the period for each of stroke and marker may be longer than or equal to any or all of the upper limits of the periods for text and shape. The upper limits of the periods for text and shape may be set differently. The upper limit of the period for each edit attribute may not be specified.

The edit attribute “image” can be classified into a still image and a moving image. In this case, the data capacity per file of the moving image is likely to be greater than that of the still image. For this reason, the upper limit of the period for the moving image may be shorter than the upper limit of the period for the still image. The upper limit of the period for the moving image may be longer than or equal to the upper limit of the period for the still image.

The types of objects may include those other than stroke, marker, text, shape, and image. The types of objects may include any of stroke, marker, text, shape, and image. For example, an object may consist of only text.

In the above embodiment, the types of objects and the edit attributes have a one-to-one correspondence. In contrast, the types of objects and the edit attributes need not have a one-to-one correspondence. For example, text and shape may be combined into a single edit attribute. Marker and stroke may be combined into a single edit attribute.

In the above embodiment, the CPU 21 may determine whether the data capacity to be determined has exceeded a third reference capacity, instead of the process in step S48, for example. The data capacity to be determined may refer to: the overall data capacity of multiple notebooks; the data capacity of each individual notebook within multiple notebooks; the overall data capacity of the history data records stored in the history storage area 224; or the data capacity of each of the history data records corresponding to a notebook or page among the history data records stored in the history storage area 224. The third reference capacity is a predetermined threshold value, and is stored in advance in the flash memory 22C shown in FIG. 1. The third reference capacity may be set based on, for example, the storage capacity of the history storage area 224. The administrator user may perform an operation for changing the third reference capacity.

When the data capacity to be determined is less than or equal to the third reference capacity, the CPU 21 may maintain the storage state of the history data record. When the data capacity to be determined exceeds the third reference capacity, the CPU 21 may delete the history data record. In this case, the CPU 21 may sequentially delete the history data records starting from the oldest edited date. The CPU 21 may sequentially delete the history data records in the order of the largest data size. The CPU 21 may sequentially delete the history data records in the order of the smallest data size.

In the above embodiment, the CPU 21 may omit some of the main process. For example, the CPU 21 may omit one or both of the processes in steps S44 and S47. The CPU 21 may omit one of the processes in steps 43 and S46. That is, in the notebook editing system 1, the change condition may include only one of the retention period and the permission setting. For example, when the retention period is not included in the change condition, the CPU 21 may omit the process in step S48. For example, when the permission setting is not included in the change condition, the CPU 21 may omit the process in step S52. The CPU 21 may omit the process in step S51. That is, the note editing system 1 may be configured to allow history data records to be deleted through delete operations regardless of whether the user is an administrator.

In the above embodiment, a history data record may be stored in the history storage area 224 for each of a plurality of edit operations. The history data record may indicate some of the edited date and time, the editor ID, the edit position, the edit attribute, and the edit content, or may indicate other information. The other information is, for example, an edit location. The edit location is the position of the user terminal 3 on the earth when the edit operation is performed.

In the above embodiment, the CPU 21 generates a history data record in the process in step S32. In contrast, the CPU 31 may generate a history data record. In this case, the CPU 31 may transmit the history data record together with the edit information to the server 2.

Instead of the CPUs 21 and 31, a microcomputer, an application-specific integrated circuit (ASIC), a field-programmable gate array (FPGA), or the like may be used as a processor. The main process may be performed by a plurality of processors. A non-transitory storage medium such as the ROMs 22A and 32A and the flash memories 22C and 32C may be any storage medium capable of retaining information regardless of the duration. The non-transitory storage medium may not include a transitory storage medium (e.g., a transmitted signal). The control program may be downloaded from a server connected to a network (not shown), that is, transmitted as a transmission signal, and stored in the ROM 22A, 32A or the flash memory 22C, 32C, for example. In this case, the control program may be stored in a non-transitory storage medium such as an HDD provided in the server.

When the CPU 21 executes a modified retention period change process in step S43, the CPU 21 may execute a modified second state change process in step S48. That is, the above-described embodiment and the above-described modifications may be combined with each other within a range where there is no inconsistency.

While the disclosure has been described in detail with reference to the specific embodiment thereof, this is merely an example, and various changes, arrangements and modifications may be applied therein without departing from the spirit and scope of the disclosure.

What is claimed is:

1. A non-transitory computer readable storage medium storing an information management program executable by a computer of an information editing system, the information editing system including a display and an operation unit and being configured to edit an object within an area displayed on the display via the operation unit, the information management program causing the computer to perform operations comprising:
storing a history data record that indicates a history corresponding to an edit operation performed on the object within the area displayed on the display via the operation unit; and
changing a change condition for a storage state of the history data record stored in the storing when a condition change operation for changing the change condition is performed via the operation unit.

2. The non-transitory computer readable storage medium according to claim 1, wherein, in the changing, when the condition change operation is performed via the operation unit, a retention period to retain the storage state is changed, as the change condition, according to an attribute of the edit operation correspondingly recorded in the history data record included in history data records stored in the storing.

3. The non-transitory computer readable storage medium according to claim 2, wherein, in the changing,
when the condition change operation is performed for the history data record corresponding to a first attribute via the operation unit, the retention period is changed within a first retention period as the change condition, and
when the condition change operation is performed for the history data record corresponding to a second attribute, which is different from the first attribute, via the operation unit, the retention period is changed within a second retention period different from the first retention period as the change condition.

4. The non-transitory computer readable storage medium according to claim 2, wherein the operations further comprise:
comparing a data capacity of a first history data record with a data capacity of a second history data record, the first history data record and the second history data record being included in the history data records; and
based on results in the comparing, changing, as the change condition, the retention period of either the first history data record or the second history data record, whichever has the smaller data capacity, within a first retention period, and the retention period of either the first history data record or the second history data record, whichever has the greater data capacity, within a second retention period shorter than the first retention period.

5. The non-transitory computer readable storage medium according to claim 2,
wherein the operations further comprise determining whether a data capacity of history data records for which the condition change operation has been performed via the operation unit is less than or equal to a predetermined threshold value,
wherein, when the data capacity of history data records is less than or equal to the threshold value in the determining, the retention period is changed within a first retention period as the change condition in the changing, and
wherein, when the data capacity of history data records is greater than the threshold value in the determining, the retention period is changed within a second retention period shorter than the first retention period as the change condition in the changing.

6. The non-transitory computer readable storage medium according to claim 2, wherein the operations further comprise deleting a history data record whose retention period has elapsed within the history data records stored in the storing.

7. The non-transitory computer readable storage medium according to claim 2, wherein the operations further comprise reducing a data capacity of history data records whose retention period has elapsed within the history data records stored in the storing.

8. The non-transitory computer readable storage medium according to claim 7,
wherein the operations further comprise comparing a data capacity of a first history data record with a data capacity of a second history data record within the history data records whose retention period has elapsed, and
wherein, in the reducing, based on results in the comparing, the smaller data capacity of either the first history data record or the second history data record is reduced by a first specified percentage, and the greater data capacity of either the first history data record or the second history data record is reduced by a second specified percentage that is greater than the first specified percentage.

9. The non-transitory computer readable storage medium according to claim 7,
wherein the operations further comprise determining whether the data capacity of history data records whose retention period has elapsed is less than or equal to a predetermined threshold value, and
wherein, when the data capacity of history data records is less than or equal to the predetermined threshold value in the determining, the data capacity of history data records is reduced by a first specified percentage in the reducing, and
wherein, when the data capacity of the history data record is greater than the predetermined threshold value in the determining, the data capacity of history data records is reduced by a second specified percentage that is greater than the first specified percentage in the reducing.

10. The non-transitory computer readable storage medium according to claim 1,
wherein the information editing system further includes a first terminal with a first operation unit and a second terminal with a second operation unit, and the information editing system is configured to edit the object via the first operation unit of the first terminal logged into the information editing system using a first ID that is previously authorized to change the storage state of the history data record and configured to edit the object via the second operation unit of the second terminal logged into the information editing system using a second ID that is not authorized to change the storage state,
wherein the operations further comprise:
determining whether an ID logged into the information editing system is the first ID or the second ID; and
changing a storage state of the history data record,
wherein, when the ID logged into the information editing system is the first ID in the determining and the condition change operation is performed via the first operation unit, the change condition in the changing includes determining whether to permit a permission setting for accepting a state change operation for changing the storage state of the history data record via the second operation unit as the change condition,
wherein, when the ID logged into the information editing system is the second ID in the determining, the changing is not performed,
wherein, when the state change operation is performed via the first operation unit, the changing a storage state changes the storage state of the history data record,
wherein, when the permission setting is not permitted, the changing a storage state does not accept the state change operation via the second operation unit, and
wherein, when the permission setting is permitted and the state change operation is performed via the second operation unit, the changing a storage state changes the storage state of the history data record.

11. A method for managing information in an information editing system that includes a display and an operation unit, the information editing system being configured to edit an object within an area displayed on the display via the operation unit, the method, comprising:
storing a history data record that indicates a history corresponding to an edit operation performed on the object within the area displayed on the display via the operation unit; and
changing a change condition for a storage state of the history data record stored in the storing when a condition change operation for changing the change condition is performed via the operation unit.
